(19) United States
(12) Patent Application Publication
(10) Pub. No.: US 2024/0057499 A1
(43) Pub. Date: Feb. 22, 2024

(54) SYSTEM AND METHOD FOR AGRICULTURAL IMPLEMENT

(71) Applicant: CNH Industrial Canada, Ltd., Saskatoon (CA)

(72) Inventor: Trevor L. Kowalchuk, Saskatoon (CA)

(21) Appl. No.: 17/889,554

(22) Filed: Aug. 17, 2022

(51) Int. Cl. A01B 63/24; A01B 76/00

(52) U.S. Cl. CPC A01B 63/24; A01B 76/00

(57) ABSTRACT

A system for identifying plugging within an agricultural implement includes a frame assembly supporting one or more components. A sensor system is operably coupled with at least one of the one or more components and configured to generate data indicative of one or more operating parameters of the at least one of the one or more components. A computing system is communicatively coupled to the sensor system. The computing system is configured to receive, from the sensor system, the data indicative of the one or more operating parameters, calculate a weight of one or more sections of the frame assembly based at least in part on the data, and identify a plugged condition when the calculated weight is less than a reference weight for a predefined amount of time.

### FIELD OF THE INVENTION

The present disclosure generally relates to agricultural implements and, more particularly, to systems and methods for identifying plugging of an agricultural implement, or portions thereof.

### BACKGROUND OF THE INVENTION

To attain better agricultural performance from a field, a farmer cultivates the soil, typically through a tillage operation. Farmers may perform the tillage operation by pulling a tillage implement behind an agricultural work vehicle, such as a tractor. Tillage implements can include one or more ground-engaging tools configured to engage the soil as the implement is moved across the field. For example, in certain configurations, the implement may include one or more harrow discs, leveling discs, rolling baskets, shanks, tines, and/or the like. Such ground-engaging tools loosen and/or otherwise agitate the soil to prepare the field for subsequent planting operations.

During the tillage operation, field materials, such as residue, soil, rocks, mud, and/or the like, may become trapped or otherwise accumulate on and/or within the ground-engaging tools or between adjacent ground-engaging tools. For instance, material accumulation may occur around the exterior of a basket assembly (e.g., on the blades or bars of the basket assembly) and/or within the interior of the basket assembly. Such accumulation of field materials may prevent the basket assembly from performing in a desired manner during the performance of the tillage operation. In such instances, the operator (or operating system) can take certain corrective actions to remove the material accumulation. However, it is typically difficult for the operator to detect or determine a plugged condition of a basket assembly or any other suitable ground-engaging tool when viewing the tools from the operator's cab.

Accordingly, an improved system and method for identifying plugging of ground-engaging tools of an agricultural implement would be welcomed in the technology.

### BRIEF DESCRIPTION OF THE INVENTION

Aspects and advantages of the invention will be set forth in part in the following description, or may be obvious from the description, or may be learned through practice of the invention.

In some aspects, the present subject matter is directed to a system for identifying plugging within an agricultural implement. The system includes a frame assembly and one or more wheel assemblies operably coupled with the frame assembly. A sensor system is operably coupled with the one or more wheel assemblies and is configured to generate data indicative of one or more operating parameters of the one or more wheel assemblies. A computing system is communicatively coupled to the sensor system. The computing system is configured to receive, from the sensor system, the data indicative of one or more operating parameters, calculate a weight of the agricultural implement based at least in part on the data, and identify a plugged condition when the calculated weight of the implement is less than a reference weight for a predefined amount of time.

In some aspects, the present subject matter is directed to a method for identifying a plugged condition within an agricultural implement. The method includes receiving, from a sensor system, data indicative of one or more operating parameters of the agricultural implement. The method also includes calculating, with a computing system, a calculated weight of the agricultural implement based at least in part on the data. Lastly, the method includes identifying, with the computing system, the plugged condition of a ground-engaging tool when the calculated weight of the implement is less than a reference weight for a predefined amount of time.

In some aspects, the present subject matter is directed to a system for identifying plugging within an agricultural implement. The system includes a frame assembly supporting one or more components. A sensor system is operably coupled with at least one of the one or more components and is configured to generate data indicative of one or more operating parameters of the at least one of the one or more components. A computing system is communicatively coupled to the sensor system. The computing system is configured to receive, from the sensor system, the data indicative of the one or more operating parameters, calculate a weight of one or more sections of the frame assembly based at least in part on the data, and identify a plugged condition of a ground-engaging tool when the calculated weight is less than a reference weight for a predefined amount of time.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an agricultural implement in accordance with aspects of the present subject matter;

FIG. 2 illustrates a top view of the agricultural implement in accordance with aspects of the present subject matter;

FIG. 3 illustrates a side perspective view of the agricultural implement in accordance with aspects of the present subject matter;

FIG. 4 illustrates a side perspective view of the agricultural implement with a central section and a pair of wing section in accordance with aspects of the present subject matter;

FIG. 5 illustrates a perspective view of a disc gang assembly of the agricultural implement in accordance with aspects of the present subject matter;

FIG. 6 illustrates a schematic diagram of a system for detecting accumulations of field materials between ground-engaging tools of an agricultural implement in accordance with aspects of the present subject matter;

FIG. 7 illustrates a graph of calculated weights of various sections of the agricultural implement in accordance with aspects of the present subject matter; and

FIG. 8 illustrates a flow diagram of a method for operating a fleet operation system in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part can be used with another embodiment to yield a still further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a harvested material within a fluid circuit. For example, “upstream” refers to the direction from which a harvested material flows, and “downstream” refers to the direction to which the harvested material moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

As used herein, a “desired foliage ratio” may be an input that is defined by an operator and/or any device. In addition, a “current foliage ratio” may be a detected foliage ratio of the system while the system is operating.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for agricultural operations. In particular, the present subject matter is directed to a system for identifying plugging within an agricultural implement.

In some instances, the system includes a frame assembly supporting one or more components. The one or more components can include one or more wheel assemblies operably coupled with the frame assembly. Additionally or alternatively, the one or more components can include a ground-engaging tool configured to be supported by the frame assembly and/or any other structure.

A sensor system can be operably coupled with at least one of the one or more components and configured to generate data indicative of one or more operating parameters of the at least one of the one or more components. In some examples, the one or more operating parameters may include a weight at various locations about the implement, a position of various components relative to other components and/or the ground surface, a load or force on various components of the frame assembly, and/or any other parameter.

A computing system can be communicatively coupled to the sensor system. In general, the computing system can include any suitable processor-based device, such as a computing device or any suitable combination of computing devices. Thus, in several embodiments, the computing system may include one or more processors 104 and associated memory configured to perform a variety of computer-implemented functions. The computing system can be configured to receive, from the sensor system, the data indicative of the one or more operating parameters. The computing system may further be configured to calculate a weight of one or more sections of the frame assembly based at least in part on the data. The computing system can also be configured to identify a plugged condition of the ground-engaging tool when the calculated weight is less than a reference weight for a predefined amount of time.

Based on the detection of the plugged condition, an appropriate control action may then be executed, such as by notifying the operator of the plugged condition or by performing an automated control action. For example, the computing system may be configured to notify the operator of the implement that field materials have accumulated between the ground-engaging tools. Moreover, in several embodiments, the computing system may be configured to automatically adjust one or more operating parameters of the implement when it is determined that a plugged condition exists. Furthermore, the computing system may be configured to adjust the ground speed at which the work vehicle is towing the implement across the field when it is determined that a plugged condition exists. As such, agricultural operation downtime may be minimized, and/or the effectiveness of the operation may be increased by minimizing plugged condition effects during the operation.

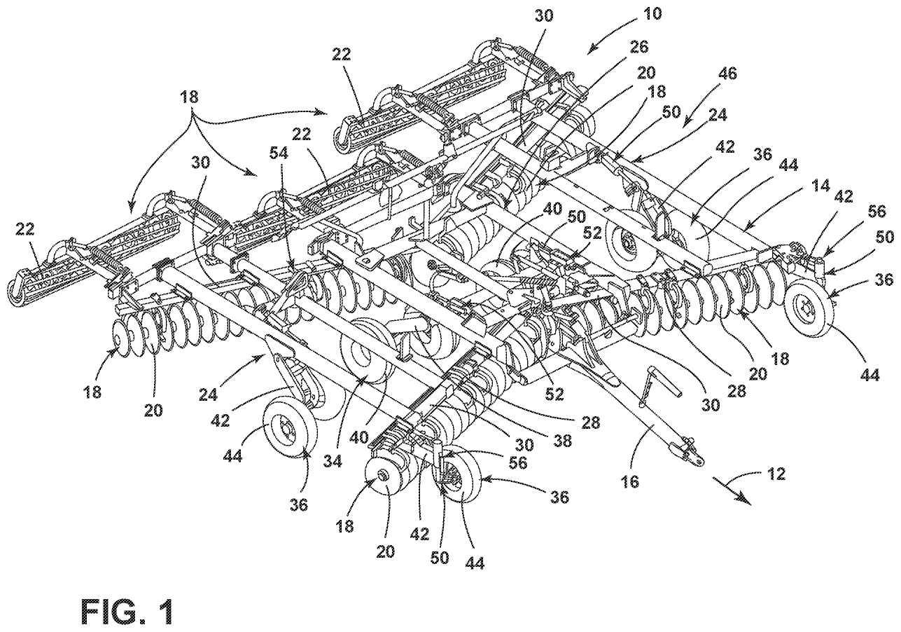

Referring now to the drawings, FIG. 1 illustrates a towable agricultural implement according to aspects of the present disclosure. In general, the implement 10 may be configured to be towed across a field in a direction of travel (e.g., as indicated by arrow 12 in FIG. 1) by a work vehicle. As shown, the implement 10 may be configured as a tillage implement, and the work vehicle may be configured as an agricultural tractor. However, in other embodiments, the implement 10 may be configured as any other suitable type of implement, such as a seed-planting implement, a fertilizer-dispensing implement, and/or the like. Similarly, the work vehicle may be configured as any other suitable type of vehicle, such as an agricultural harvester, a self-propelled sprayer, and/or the like.

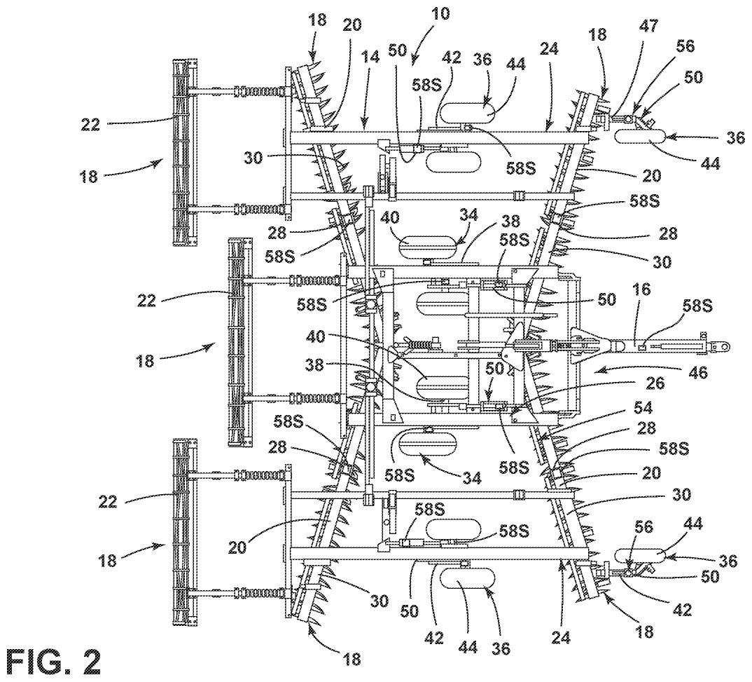

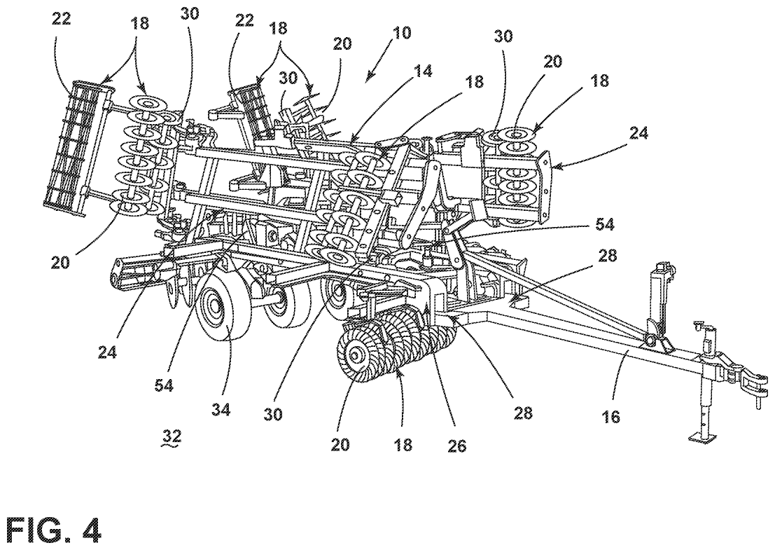

Additionally, as shown in FIGS. 1-4, the agricultural implement 10 may generally include a carriage frame assembly 14 configured to be towed by the work vehicle via a pull hitch or towbar 16 in a travel direction of the vehicle (e.g., as indicated by arrow 12). In various examples, the carriage frame assembly 14 may be configured to support one or more ground-engaging tools 18, such as shanks, disk gang assemblies 20, leveling blades, basket assemblies 22, and/or the like. The various ground-engaging tools 18 may be configured to perform a tillage operation across the field along which the agricultural implement 10 is towed.

As provided in the illustrated examples, the frame assembly 14 can include a pair of left and right rotatable wing sections 24 connected to a central section 26 of the frame assembly 14 on opposing lateral sides of the central section 26 by a plurality of hinged joints 28 that allow the wing section 24 to be folded relative to the central section 26. The implement 10 may further be configured to utilize these hinged joints 28 in a manner that allows the wing section 24 to flex with respect to the central section 26 as the implement 10 is towed across the ground surface 32 during tillage operations.

The implement 10 can also include segmented front and rear ground-engaging tools 18, in the form of front and rear disk gang assemblies 20, that are operatively joined to the frame assembly 14 by front and rear segmented toolbars 30 respectively. As shown in FIGS. 1-4, the implement 10 can also include surface finishing tools, which may be in the form of rotating basket assemblies 22, operatively attached to the rear portion of the implement 10. The toolbars 30 and disk gang assemblies 20 can be segmented and attached to the central section 26 and/or the wing section 24 in a manner that allows the wing section 24 and the segments of the front and rear disk gang assemblies 20 to be folded above the central section 26. Similarly, the surface finishing tools can also be segmented and attached to the central section 26 and/or the wing section 24 in a manner that allows the wing section 24 and the surface finishing tools operably coupled therewith to be folded above the central section 26, to thereby narrow the implement 10 for transport on public roadways.

As shown in FIGS. 1-4, the implement 10 can be supported above a ground surface 32 by one or more central section support wheel assemblies 34 and/or the wing frame support wheel assemblies 36. The central section support wheel assemblies 34 can include a central section support 38 and a wheel 40, among other components. In such instances, the central section support 38 may operably couple the frame assembly 14 to the wheel 40. Similarly, the wing frame support wheel assemblies 36 can include a wing section support 42 and a wheel 44, among other components. In such instances, the wing section support 42 may be operably coupled with the frame assembly 14 and the wheel 44.

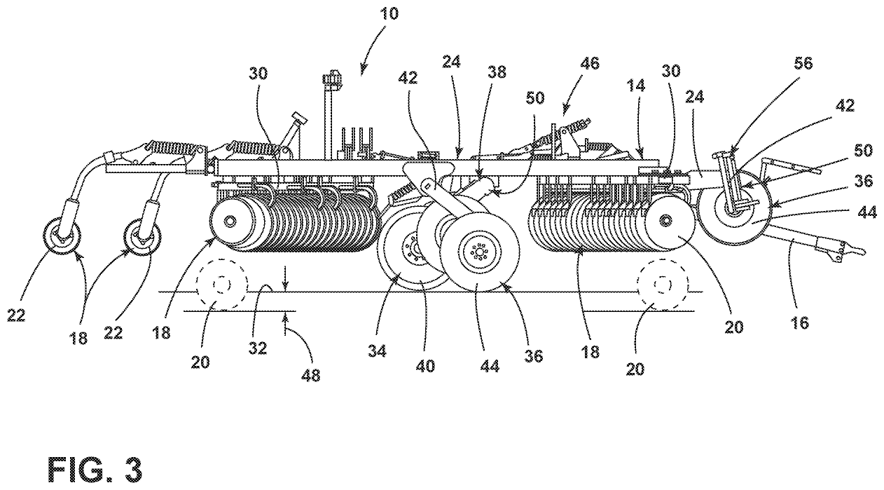

In addition, the central section support wheel assemblies 34 and the wing section wheel assemblies 36 can be operably coupled to the frame assembly 14 by an adjustment system 46. The adjustment system 46 may be configured to set and maintain a depth of penetration 48 of the ground-engaging tools 18 below the ground surface 32, and as indicated schematically in FIG. 3. Additionally or alternatively, the adjustment system 46 may further be configured to rotate the wing section 24.

In various examples, the adjustment system 46 may include one or more actuators 50, which may be hydraulic actuators, electric actuators, pneumatic actuators, and/or any other device, to move one component of the implement 10 relative to another component. For example, a first set 52 of actuators 50 may be operably coupled with the frame and the central section support wheel assemblies 34 to increase/decrease a distance between the frame assembly 14 and the ground surface 32. As such, when the distance between the frame assembly 14 and the ground surface 32 is decreased, the ground-engaging tools 18 may be inserted further into the ground surface 32. Conversely, when the distance between the frame assembly 14 and the ground surface 32 is increased, the ground-engaging tools 18 may be moved to a lesser depth into the ground and/or separated from the ground surface 32.

The adjustment system 46 may further include a second set 54 of actuators 50 that may be operably coupled with the central section 26 and the wing section 24 to rotate the wing sections 24 relative to the central section 26 about the joints 28.

The adjustment system 46 can further include a third set 56 of actuators 50 that may be operably coupled with the central section 26 and the wing section wheel assemblies 36 to increase/decrease a distance between the wings and the ground surface 32, which may be done to maintain the implement 10 in a generally level position. As such, when the distance between the frame assembly 14 and the ground surface 32 is decreased, the ground-engaging tools 18 may be inserted further into the ground surface 32. Conversely, when the distance between the frame assembly 14 and the ground surface 32 is increased, the ground-engaging tools 18 may be moved to a lesser depth into the ground and/or separated from the ground surface 32.

In some examples, the adjustment system 46 can be configured such that when the wing section 24 is lowered, as shown in FIGS. 1-3, the central section support wheel assemblies 34 and the wing frame wheel assemblies 36 act together to support the implement 10 above the ground surface 32. In FIG. 3, the implement 10 is shown in a raised, field transport condition, where the central section support wheel assemblies 34 and the wing frame wheel assemblies 36, and the adjustment system 46 have lifted the disk gang assemblies 20 out of contact with the ground surface 32. When the wing section 24 is lowered to a working configuration, as shown in FIGS. 1-3, and the adjustment system 46 is commanded to lower the implement 10 to a working position, the front and rear gang assemblies 20 of ground-engaging tools 18 will penetrate the ground surface 32 to the depth of penetration 48, as indicated by dashed lines in FIG. 3.

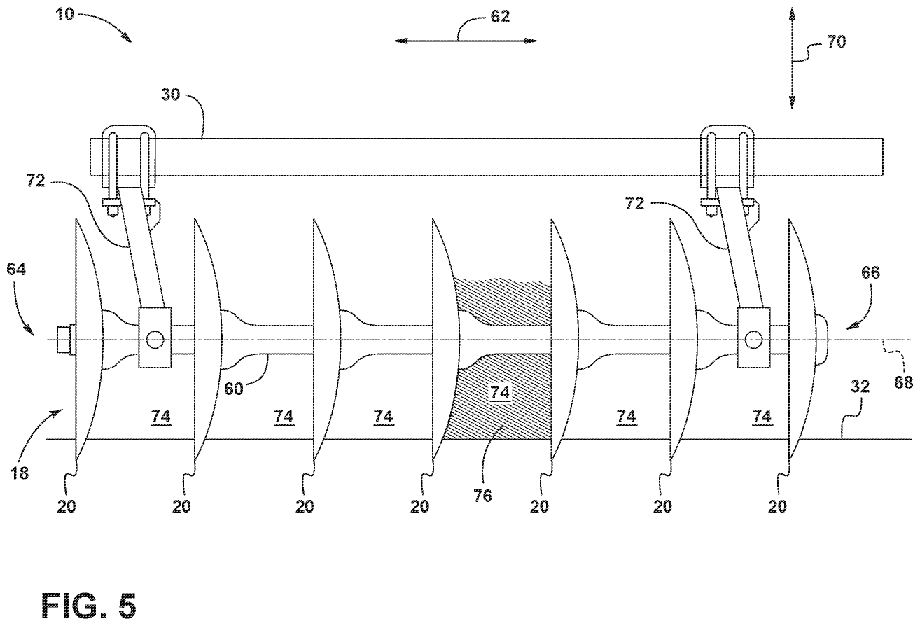

Referring now to FIG. 5, a front view of a disc gang assembly 20 of the implement 10 is illustrated in accordance with aspects of the present subject matter. In several embodiments, the disc gang assembly 20 may include a disc gang assembly shaft 60 that extends along an axial direction of the disc gang assembly 20 (e.g., as indicated by arrow 62 in FIG. 5) between a first end portion 64 and a second end portion 66. As shown, the disc blades may be rotatably coupled to the disc gang assembly shaft 60 and spaced apart from each other along the axial direction 62. As the implement 10 is moved across a field, the disc blades may be configured to penetrate the ground surface 32 of the field and rotate about an axis of rotation (e.g., as indicated by dashed line 68 in FIG. 3) relative to the soil within the field. Furthermore, the disc gang assembly shaft 60 may be positioned below the toolbar 30 of the disc gang assembly 20 along a vertical direction (e.g., as indicated by arrow 70 in FIG. 3) of the implement 10. As such, the disc gang assembly 20 may include one or more hangers 72 configured to support the disc gang assembly 20 relative to the toolbar 30. However, in alternative embodiments, the disc gang assembly 20 may have any other suitable configuration.

As shown in FIG. 5, the disc gang assembly 20 may define one or more field material flow zones 74 through which field materials may flow during the operation of the implement 10. For instance, each flow zone 74 may be defined between a pair of adjacent disc blades in the axial direction 62 and, possibly, below the axis of rotation 68 in the vertical direction 70. As such, each flow zone 74 may be defined below the disc gang assembly shaft 60.

As the implement 10 is moved across the field, field materials (e.g., soil, residue, rocks, and/or the like) may flow through the flow zone(s) 74. In certain instances, however, the field materials may accumulate within the flow zone(s) 74. For example, when the soil in the field has a high moisture content, the soil may stick or adhere to the disc blades such that the soil accumulates with the associated flow zone(s) 74. Moreover, a large chunk of residue or a rock may become lodged between a pair of adjacent disc blades in a manner that inhibits the flow of the field materials through the associated flow zone(s) 74, thereby causing additional field materials to accumulate therein. When the accumulation of the field materials between a pair of adjacent disc blades is sufficient to inhibit the flow of further field materials through the associated flow zone 74, the flow zone may be defined as plugged. For instance, as shown in FIG. 5, the accumulation of field materials (e.g., as indicated by cross-hatched region 76 in FIG. 5) within one of the flow zones 74 has caused this flow zone to be plugged.

Referring back to FIGS. 1-4, the implement 10 may incorporate a sensor system 58 that is configured to generate data indicative of one or more operating parameters of the implement 10. In some examples, the one or more operating parameters may include a weight at various locations about the implement 10, a position of various components relative to other components and/or the ground surface 32, a load or force on various components of the frame assembly 14, and/or any other parameter. In turn, the data may be used to calculate a weight of the agricultural implement 10 based at least in part on the data. In some instances, a plugged condition of the ground-engaging tool 18 may be identified when the calculated weight of the implement 10 is less than a reference weight for a predefined amount of time.

In several embodiments, one or more of the weight sensors 58s may be mounted on the central section support wheel assemblies 34 and/or the wing frame support wheel assemblies 36, the implement adjustment system 46, hinged joints 28 that allow the wing section 24 to be folded relative to the central section 26, the towbar 16, and/or any other component.

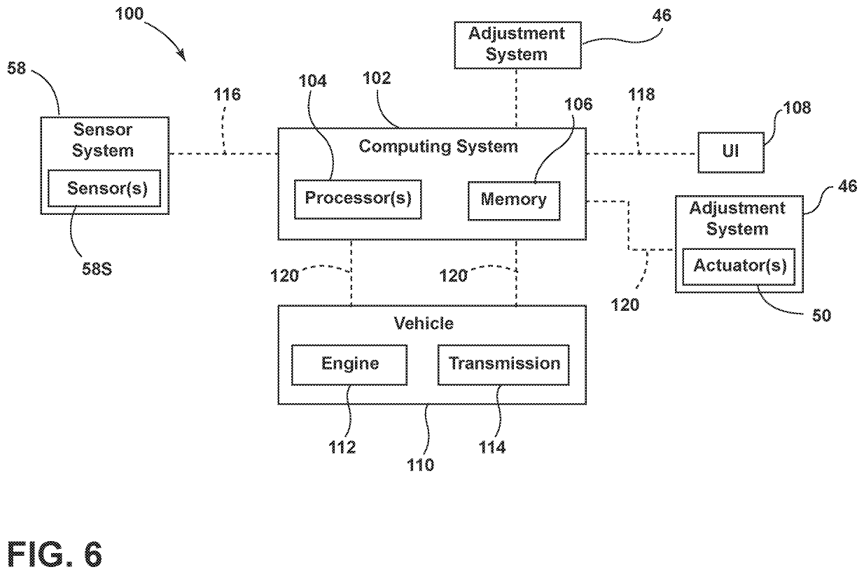

In various examples, the sensor system 58 may include one or more weight sensors 58s that may output a signal that corresponds to the weight of one or more components of the implement 10. During normal, non-plugged operation of the implement 10, the calculated weight from the weight sensor 58s may be relatively consistent. Conversely, with an accumulation of field materials on and/or within a ground-engaging tool 18, the calculated weight from weight sensor 58s may decrease. By detecting the decrease in the calculated weight from weight sensor 58s, an associated controller or computing system 102 (FIG. 6) may infer or determine that at least one ground-engaging tool 18 of the implement 10 is currently plugged or experiencing a plugged condition. For instance, the computing system 102 (FIG. 6) may be configured to compare the calculated weight from weight sensor 58s to a reference weight, which corresponds to the normal, non-plugged weight of the implement 10, and the computing system 102 (FIG. 6) may determine the existence of material accumulation on or within the ground-engaging tool 18 in response to the calculated weight from weight sensor 58s is less than the reference weight by a predetermined difference for a predefined time. Once it is determined that the ground-engaging tool 18 is plugged, an appropriate control action may then be executed, such as by notifying the operator of the plugged condition or by performing an automated control action.

In some examples, a weight sensor 58s may be respectively coupled with the central section support wheel assemblies 34 and/or the wing frame support wheel assemblies 36. For example, the weight sensors 58s may be configured as load cells, such as hydraulic load cells, pneumatic load cells, piezoelectric load cells, and/or strain gauges.

Additionally or alternatively, the weight sensors 58s may be configured as a pressure sensor operably coupled with an actuator, such as the first set 52 of actuators 50, the second set 54 of actuators 50, and/or the third set 56 of actuators 50, within the adjustment system 46. In such instances, a reference weight may be determined prior to an agricultural operation based on the known pressure within the actuator. During operation, a detected pressure may be monitored to determine any weight changes. As provided herein, the computing system 102 (FIG. 6) may be configured to compare the calculated weight from weight sensor 58s to a reference weight, which corresponds to the normal, non-plugged weight of the implement 10, and the computing system 102 (FIG. 6) may determine the existence of material accumulation on or within the ground-engaging tool 18 in response to the calculated weight from weight sensor 58s is less than the reference weight by a predetermined difference for a predefined time.

Additionally or alternatively, the sensor system 58 may include one or more rotation sensors 58s operably coupled with the hinged joints 28 that allow the wing section 24 to be folded relative to the central section 26. In various examples, the rotation sensor 58s may be configured as an inductive sensor, Hall Effect sensor, magnetoresistive sensor, optical sensor, and/or any other type of practicable sensor. In such instances, the one or more rotation sensors 58s may be capable of determining a reference angle between the wing section 24 and the central section 26 of the implement 10 prior to an agricultural operation. During operation, a detected angle may be monitored to determine any weight changes based on a correlation between the angle and a calculated weight of the wing section 24 and/or the central section 26. As provided herein, the computing system 102 (FIG. 6) may be configured to compare the calculated weight from the rotation sensor 58s to a reference weight, which corresponds to the normal, non-plugged weight of the implement 10, and the computing system 102 (FIG. 6) may determine the existence of material accumulation on or within the ground-engaging tool 18 in response to the calculated weight based at least in part on data from the rotation sensor 58s to determine that the weight of the wing section 24 is less than the reference weight by a predetermined difference for a predefined time.

In addition, the calculated weight of a first wing section 24 may be compared to the calculated weight of a second wing section 24. When the calculated weight of the first wing section 24 differs from the calculated weight of the second wing section 24 by a predetermined difference for a predefined time, the computing system 102 (FIG. 6) may determine the existence of material accumulation on or within the ground-engaging tool 18.

Additionally or alternatively, the sensor system 58 can include a resistive sensor 58s that may be operably coupled with the towbar 16 (e.g., one or more draft tubes) to detect a resistive force on the hitch or hitch members. In various examples, the resistive sensor 58s may be configured as a load sensor, a force gauge, a piezoelectric sensor, a flex sensor, and/or any other device. In such instances, the one or more resistive sensors 58s may be capable of determining a reference force on a portion of the implement 10 prior to an agricultural operation. During operation, a detected force may be monitored to determine any weight changes based on a correlation between the force and the calculated weight of the implement 10. As provided herein, the computing system 102 (FIG. 6) may be configured to compare the calculated weight from the resistive sensor 58s to a reference weight, which corresponds to the normal, non-plugged weight of the implement 10, and the computing system 102 (FIG. 6) may determine the existence of material accumulation on or within the ground-engaging tool 18 in response to the calculated weight based at least in part on data from the resistive sensor 58s to determine that the weight of the implement 10 is less than the reference weight by a predetermined difference for a predefined time.

Referring now to FIG. 6, a schematic diagram of a system 100 for detecting accumulations of field materials between ground-engaging tools 18 of an agricultural implement 10 is illustrated in accordance with aspects of the present subject matter. In general, the system 100 will be described herein with reference to the implement 10 described above with reference to FIGS. 1-5. However, it will be appreciated by those of ordinary skill in the art that the disclosed system 100 may generally be utilized with agricultural implements 10 having any other suitable implement configuration and/or work vehicles having any other suitable vehicle configuration.

As shown in FIG. 6, the system 100 may include a computing system 102 configured to electronically control the operation of one or more components of the implement 10 and/or the work vehicle 110. In general, the computing system 102 can include any suitable processor-based device, such as a computing device or any suitable combination of computing devices. Thus, in several embodiments, the computing system 102 may include one or more processors 104 and associated memory 106 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 106 of the computing system 102 may generally comprise memory elements including, but not limited to, a computer-readable medium (e.g., random access memory (RAM)), a computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 106 may generally be configured to store information accessible to the processor 104, including data that can be retrieved, manipulated, created, and/or stored by the processor 104 and instructions that can be executed by the processor 104 and configure the computing system 102 to perform various computer-implemented functions, such as one or more algorithms and/or related methods. In addition, the computing system 102 may also include various other suitable components, such as a communications circuit or module, one or more input/output channels, a data/control bus, and/or the like.

It will be appreciated that the computing system 102 may correspond to an existing controller of the implement 10 or the work vehicle 110 or the computing system 102 may correspond to a separate processing device. For instance, the computing system 102 may form all or part of a separate plug-in module that may be installed within the implement 10 or the work vehicle 110 to allow for the disclosed system and method to be implemented without requiring additional software to be uploaded onto existing control devices of the implement 10 or the work vehicle 110.

Furthermore, the system 100 may also include the user interface 108. In various examples, the user interface 108 may be configured to provide feedback (e.g., notifications associated with plugging of the ground-engaging components of the implement 10) to the operator of the implement 10. As such, the user interface 108 may include one or more feedback devices, such as display screens, speakers, warning lights, and/or the like, which can be configured to communicate such feedback. In addition, some examples of the user interface 108 may include one or more input devices, such as touchscreens, keypads, touchpads, knobs, buttons, sliders, switches, mice, microphones, and/or the like, which are configured to receive user inputs from the operator. In various cases, the user interface 108 may be positioned within the cab of the work vehicle 110. Additionally or alternatively, the user interface 108 may have any suitable configuration and/or be positioned in any other suitable location.

In several embodiments, the computing system 102 may further be coupled with the sensor system 58. As provided herein, the sensor system 58 may be configured to receive data related to the operating parameters of the implement 10 (e.g., indicated by dashed line 116 in FIG. 6). In turn, the computing system 102 may determine an estimated implement weight based at least in part on the data. Additionally, the computing system 102 may be configured to compare the calculated weight to a reference weight, which corresponds to the normal, non-plugged weight of the implement 10 (or a portion thereof (e.g., a wing section 24)). In turn, the computing system 102 may identify a plugged condition on or within the ground-engaging tool 18 in response to the calculated weight being less than the reference weight by a predetermined difference for a predefined time.

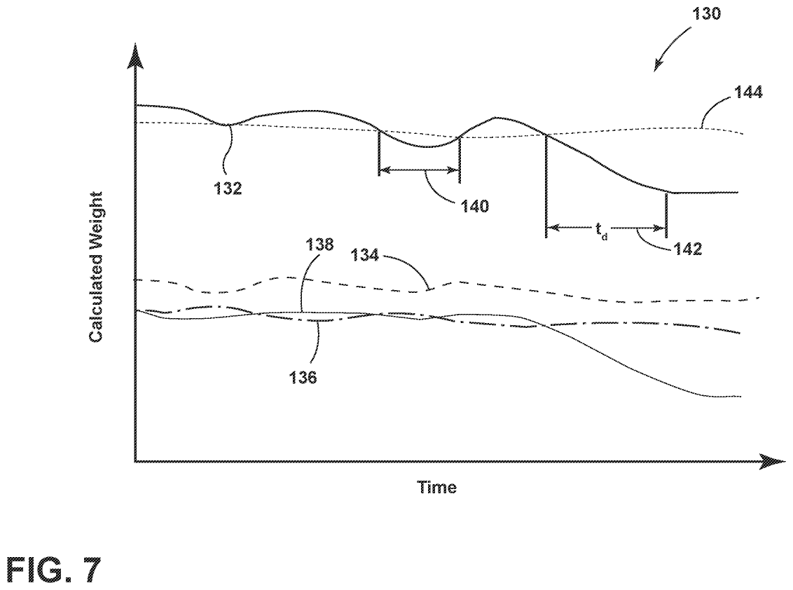

With reference to FIG. 7, an example graph 130 of calculated weight over time is illustrated in accordance with aspects of the present disclosure. As illustrated, the calculated weight may vary during the agricultural operation. As shown in FIG. 7, the computing system 102 may calculate a total weight, as indicated by line 132, along with a calculated weight of the central section 26, as indicated by line 134, a calculated weight of the first wing section 24, as indicated by line 136, and/or a calculated weight of the second wing section 24, as indicated by line 138.

As illustrated in FIG. 7, as the operation is performed, each of the calculated total weight and the calculated section weights may be monitored and compared to a defined weight, which is illustrated by line 144 in FIG. 7, or weight range. As shown, the calculated total weight may be less than the defined weight 144 for a first time, as indicated by arrow 140. However, the calculated total weight is less than the defined weight 144 before the expiration of the predefined time t_{d}. As such, the computing system 102 may not identify that the implement 10 is currently experiencing a plugged condition.

As shown, the calculated total weight may is less than the defined weight 144 at a second time, as indicated by arrow 142. In addition, as the calculated total weight deviates from the defined weight 144 for more than the predefined time t_{d}, the computing system 102 may identify the implement 10 as currently experiencing a plugged condition. Furthermore, the computing system 102 may compare the calculated weights of each section to previous weights of each respective section and/or to one another, the computing system 102 may identify the second wing section 24 as the location creating the plugged condition.

Referring back to FIG. 6, once it is determined that the ground-engaging tool 18 is plugged, an appropriate control action may then be executed, such as by notifying the operator of the plugged condition or by performing an automated control action. For example, the computing system 102 may be configured to notify the operator of the implement 10 that field materials have accumulated between the ground-engaging tools 18. For instance, the computing system 102 may be communicatively coupled to the user interface 108 via a wired or wireless connection to allow feedback signals (e.g., indicated by dashed line 118 in FIG. 6) to be transmitted from the computing system 102 to the user interface 108. In such embodiment, the feedback signals 118 may instruct the user interface 108 to provide a notification to the operator of the implement 10 (e.g., by causing a visual or audible notification or indicator to be presented to the operator) that indicates that the field has accumulated between the ground-engaging tools 18 of the implement 10. In such instances, the operator may then choose to initiate any suitable corrective action they believe is beneficial, such as adjusting one or more operating parameters of the implement 10 and/or the work vehicle 110.

Moreover, in several embodiments, the computing system 102 may be configured to automatically adjust one or more operating parameters of the implement 10 when it is determined that a plugged condition exists. Specifically, as shown in FIG. 6, the computing system 102 may be communicatively coupled to the adjustment system 46 of the implement 10 via a wired or wireless connection to allow control signals (e.g., as indicated by dashed lines 120 in FIG. 6) to be transmitted from the computing system 102 to the actuator(s) 50. As such, the computing system 102 may be configured to transmit control signals 120 to the actuator(s) 50 of the adjustment system 46 instructing the actuator(s) 50 to adjust the angle of the disc gang assembly(s) 20 relative to the lateral centerline of the frame assembly 14, the penetration depth of the associated disc blade(s), and/or the orientation of the wing sections 24 to the central section 26. Additionally or alternatively, the computing system 102 may be configured to transmit control signals 120 to a solenoid on a hydraulic valve block to alter hydraulic cylinders on the implement to adjust the angle of the disc gang assembly(s) 20 relative to the lateral centerline of the frame assembly 14, the penetration depth of the associated disc blade(s), and/or the orientation of the wing sections 24 to the central section 26. Additionally or alternatively, the control signals 120 may be provided through an Isobus (e.g., Isobus class 3 control system) to actuate one or more hydraulic valves on the vehicle 110 to actuate the hydraulic cylinders on the implement to adjust the angle of the disc gang assembly(s) 20 relative to the lateral centerline of the frame assembly 14, the penetration depth of the associated disc blade(s), and/or the orientation of the wing sections 24 to the central section 26.

Furthermore, the computing system 102 may be configured to adjust the ground speed at which the work vehicle 110 is towing the implement 10 across the field when it is determined that a plugged condition exists. For example, the computing system 102 may be communicatively coupled to an engine 112 and/or a transmission 114 of the work vehicle 110 via a wired or wireless connection to allow control signals 120 to be transmitted from the computing system 102 to the engine 112 and/or the transmission 114. For example, the control signals 128 may be configured to instruct the engine 112 to vary its power output to increase or decrease the ground speed of the work vehicle 110 in a manner that removes the accumulated field materials from the ground-engaging tools 18, and/or prevents further accumulation of such materials. Similarly, the control signals 128 may be configured to instruct the transmission 114 to upshift or downshift to change the ground speed of the work vehicle 110 in a manner that removes the accumulated field materials from the ground-engaging tools 18 and/or prevents further accumulation of such materials. However, it will be appreciated that, in alternative embodiments, the computing system 102 may be configured to transmit control signals to any other suitable component of the work vehicle 110 and/or implement 10 such that the ground speed of the work vehicle 110 and/or implement 10 is adjusted.

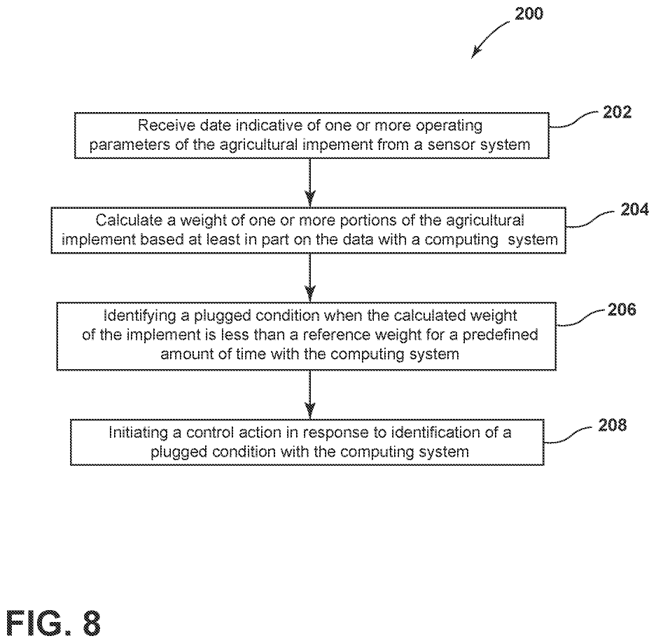

Referring now to FIG. 8, a flow diagram of a method 200 for identifying a plugged condition within an agricultural implement is illustrated in accordance with aspects of the present subject matter. In general, the method 200 will be described herein with reference to the system 100 and related components described with reference to FIGS. 1-7. It will be appreciated, however, that the disclosed method 200 may be implemented with any implement having any other suitable configurations and/or within systems having any other suitable system configuration. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 8, at (202), receiving, from a sensor system, data indicative of one or more operating parameters of the agricultural implement. As provided herein, the sensor system is configured to generate data indicative of one or more operating parameters of the implement. In some examples, the one or more operating parameters may include a weight at various locations about the implement, a position of various components relative to other components and/or the ground surface, a load or force on various components of the frame assembly, and/or any other parameter.

At (204), the method 200 can include calculating a weight of a portion of the agricultural implement based at least in part on the data with a computing system. In various examples, the data can include at least the weight data of a central section of a frame assembly of the implement. In such instances, calculating the weight of the agricultural implement based at least in part on the data can include determining a weight of the implement based on the weight data of the central section frame. Additionally or alternatively, in some examples, the data can include at least weight data of a first wing section of a frame of the implement and a second wing section of the frame assembly. In such examples, calculating the weight of the agricultural implement based at least in part on the data can include determining a weight of the implement based on the weight data of the central section frame.

At (206), the method 200 can include identifying, with the computing system, the plugged condition of a portion of the implement when the calculated weight of the portion of the implement is less than a reference weight for a predefined amount of time. In various instances, a plugged condition may occur in individual portions of the implement. As such, in some examples, identifying, with the computing system, the plugged condition of a portion of the implement can include identifying the plugged condition by comparing the weight measurement from each sensor within a sensor system to a defined weight. When the weight received by a single sensor is less than a defined weight for that location or portion of the implement, the plugged condition may be identified. Moreover, the position of each sensor relative to the implement may be known so that the location of the plugged condition within the implement may be identified.

At (208), the method 200 can include initiating a control action in response to the identification of a plugged condition with the computing system. In some cases, the control action includes activating an adjustment system. In such cases, activating the adjustment system includes altering a position of one or more sections of a frame assembly of the implement through one or more actuators. Additionally or alternatively, activating the adjustment system includes altering a position of a wing section of a frame assembly of the implement relative to a central section of the frame assembly.

In various examples, the method 200 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update the position of the ground-engaging tool and/or any other component of the residue manager assembly. In some instances, the vehicle learning engine may allow for changes to the position of the ground-engaging tool and/or any other component of the residue manager assembly to be performed without human intervention.

It is to be understood that the steps of any method disclosed herein may be performed by a computing system upon loading and executing software code or instructions which are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions which are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or instructions that influence the operation of a computer or controller. They may exist in a computer-executable form, such as vehicle code, which is the instructions and data directly executed by a computer's central processing unit or by a controller, or a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for identifying plugging within an agricultural implement, comprising:
a frame assembly;
one or more wheel assemblies operably coupled with the frame assembly;
a sensor system operably coupled with the one or more wheel assemblies and configured to generate data indicative of one or more operating parameters of the one or more wheel assemblies; and
a computing system communicatively coupled to the sensor system, the computing system configured to:
receive, from the sensor system, the data indicative of one or more operating parameters;
calculate a weight of the agricultural implement based at least in part on the data; and
identify a plugged condition of the implement when the calculated weight of the implement is less than a reference weight for a predefined amount of time.

2. The system of claim 1, wherein the frame assembly defines a central section, a first wing section on a first lateral side of a central section, and a second wing section on an opposing second lateral side of the central section.

3. The system of claim 2, wherein the one or more wheel assemblies is a central section wheel assembly including a central section support and a wheel.

4. The system of claim 3, wherein the sensor system includes a weight sensor operably coupled with the central section support.

5. The system of claim 2, wherein the one or more wheel assemblies includes a first wing frame support wheel assembly operably coupled with the first wing section and including a first wing section support and a first wheel and a second wing frame support wheel assembly operably coupled with the second wing section and including a second wing section support and a second wheel.

6. The system of claim 5, wherein the sensor system includes a first weight sensor operably coupled with the first wing section support and a second weight sensor operably coupled with the second wing section support.

7. The system of claim 2, wherein the sensor system includes a first sensor operably coupled with the central section, a second sensor operably coupled with the first wing section, and a third sensor operably coupled with the second wing section, and wherein the computing system is further configured to determine the calculated weight of the implement based on the data provided by the first sensor, the second sensor, and the third sensor.

8. The system of claim 1, further comprising:
an adjustment system operably coupled with the one or more wheel assemblies operably coupled with the frame assembly, wherein the computing system is further configured to activate the adjustment system when the plugged condition is identified.

9. A method for identifying a plugged condition within an agricultural implement, the method comprising:
receiving, from a sensor system, data indicative of one or more operating parameters of the agricultural implement;
calculating, with a computing system, a calculated weight of a portion of the agricultural implement based at least in part on the data; and
identifying, with the computing system, the plugged condition of the portion of the implement when the calculated weight of the portion of the implement is less than a reference weight for a predefined amount of time.

10. The method of claim 9, wherein the data includes at least weight data of a central section of a frame assembly of the implement, and wherein calculating the weight of the agricultural implement based at least in part on the data includes determining a weight of the implement based on the weight data of the central section frame.

11. The method of claim 10, wherein the data includes at least weight data of a first wing section of the frame assembly of the implement and a second wing section of the frame assembly, and wherein calculating the weight of the agricultural implement based at least in part on the data includes determining a weight of the implement based on the weight data of the central section frame.

12. The method of claim 10, further comprising:
initiating, with the computing system, a control action in response to the identification of the plugged condition.

13. The method of claim 12, wherein the control action includes activating an adjustment system.

14. The method of claim 13, wherein activating the adjustment system includes altering a position of one or more sections of the frame assembly of the implement through one or more actuators.

15. The method of claim 13, wherein activating the adjustment system includes altering a position of a wing section of the frame assembly of the implement relative to the central section of the frame assembly.

16. A system for identifying plugging within an agricultural implement, comprising:
a frame assembly supporting one or more components;
a sensor system operably coupled with at least one of the one or more components and configured to generate data indicative of one or more operating parameters of the at least one of the one or more components; and
a computing system communicatively coupled to the sensor system, the computing system configured to:
receive, from the sensor system, the data indicative of the one or more operating parameters;
calculate a weight of one or more sections of the frame assembly based at least in part on the data; and
identify a plugged condition of a ground-engaging tool when the calculated weight is less than a reference weight for a predefined amount of time.

17. The system of claim 16, wherein the one or more sections include a central section.

18. The system of claim 17, wherein the one or more sections includes a first wing section on a first lateral side of the central section and a second wing section on an opposing second lateral side of the central section.

19. The system of claim 18, wherein the sensor system includes one or more sensors operably coupled with a wheel assembly of the central section, the first wing section, or the second wing section.

20. The system of claim 18, wherein the sensor system includes a position sensor configured to generate data indicative of a position of the first wing section relative to the central section.
